(19) United States
(12) Patent Application Publication
(10) Pub. No.: US 2007/0280293 A1
(43) Pub. Date: Dec. 6, 2007

(54) System and method for implementing video streaming over IP networks

(75) Inventor: Yasantha Nirmal Rajakarunanayake, San Ramon, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 11/729,927

(22) Filed: Mar. 30, 2007

Related U.S. Application Data
(60) Provisional application No. 60/811,116, filed on Jun. 6, 2006.

(51) Int. Cl. H04J 3/24

(52) U.S. Cl. 370/474

(57) ABSTRACT

A system and method that completely removes the host CPU of an IP gateway/set-top video server from the data path of handling of network packet headers, as required by protocol layers such as UDP, IP, or Ethernet, or of payloads during video streaming. Accordingly, an ordinary set-top server is made operable to support simultaneous high definition video streams or additional such data streams.

### CROSS-REFERENCE TO RELATED APPLICATIONS

The present application claims the benefit of U.S. Provisional Patent Application No. 60/811,116 filed on Jun. 6, 2006, which is incorporated herein by reference in its entirety.

### BACKGROUND OF THE INVENTION

1. Field of the Invention

The present invention generally relates to video streaming over an Internet Protocol network.

2. Background Art

As broadband Internet access has reached wide accessibility, streaming high bit rate video has become a major part of the Internet experience for many users. One application of video streaming is the delivery of Internet Protocol Television (“IPTV”) to IPTV-capable devices. A typical configuration for IPTV delivery involves the use of a closed network infrastructure created specifically for the purpose of video delivery, such as what is commonly termed Video On Demand (“VOD”). VOD services are typically offered by digital cable television (“CATV”) providers, but may also be offered by other telecommunications providers, such as fiber optic and wireless network carriers.

With the availability of these services comes the desire to allow users with several display systems to utilize IPTV services. Many households have more than one television, and therefore it is advantageous to allow users to view IPTV programming on any available television, preferably concurrently with IPTV programming being viewed on a separate television. However, the processing demands of transmitting IPTV programming to various displays, particularly in the case of high definition television (“HDTV”) video, are significant for a typical set-top box (“STB”). While state-of-the-art processor systems can be implemented in new STBs for the purposes of sending IPTV programming to multiple displays, the cost of replacing existing STBs with the latest technology on a regular basis becomes cost-prohibitive for IPTV programming providers.

Transmitting IPTV programming requires the addition and removal of header information at various protocol layer transitions, such as when Transmission Control Protocol (“TCP”) or User Datagram Protocol (“UDP”) packets are sent or received within an Internet Protocol (“IP”) packet. For example, in order to send a formed TCP packet over an IP network, an IP header is added to form an IP packet, which can then be sent over the IP network. The repetitive work performed on headers can often cause the transmission process to consume most of the processing resources available in a STB's CPU. Even if the STB is only transmitting a single IPTV programming stream, CPU resources may be necessary for other common tasks performed by STBs, such as recording programming for later viewing, as in a digital video recorder (“DVR”).

Accordingly, what is desired is a system, method, and computer program product for utilizing existing STBs to transmit IPTV programming signals in an efficient manner.

### BRIEF SUMMARY OF THE INVENTION

The invention includes a method for streaming data at a high bit rate, in accordance with an embodiment of the present invention. The method includes the steps of computing header data for the data stream, wherein the header data is computed by a processor prior to transmission of the data stream, gathering payload data in a network module, wherein the payload data corresponds to a constituent portion of the data stream, fetching the precomputed header data in a network module, wherein the precomputed header data is stored in a separate memory location from the payload data, and transmitting the formed data packet by sending the precomputed header data along with the gathered payload data in a network module.

The invention additionally includes a computer program product comprising a computer usable medium having computer program logic recorded thereon for enabling a processor to stream data at a high bit rate, in accordance with an embodiment of the present invention. The computer program logic includes computing means for enabling a processor to compute header data for the data stream, wherein the header data is computed by the processor prior to transmission of the data stream, gathering means for enabling a processor to gather payload data in a network module, wherein the payload data corresponds to a constituent portion of the data stream, fetching means for enabling a processor to fetch the precomputed header data in a network module, wherein the precomputed header data is stored in a separate memory location from the payload data, and transmitting means for enabling a processor to transmit the formed data packet by sending the precomputed header data along with the gathered payload data in a network module.

The invention further includes a system capable of streaming data at a high bit rate, in accordance with an embodiment of the present invention. The system includes a first module to compute header data for the data stream, wherein the header data is computed by a processor prior to transmission of the data stream, a second module to gather payload data in a network module, wherein the payload data corresponds to a constituent portion of the data stream, a third module to fetch the precomputed header data in a network module, wherein the precomputed header data is stored in a separate memory location from the payload data, and a fourth module to transmit the formed data packet by sending the precomputed header data along with the gathered payload data in a network module.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 illustrates an exemplary embodiment of a network designed to distribute streaming video to a client pool, in accordance with an embodiment of the present invention.

FIG. 2 illustrates a conventional gateway configuration for the purpose of streaming video to a client.

FIG. 3 illustrates a gateway configuration, in accordance with an embodiment of the present invention.

FIG. 4 is a flowchart illustrating steps by which a gateway is operable to prepare and transmit packets of a data stream, in accordance with an embodiment of the present invention.

FIG. 5 is a signal flow/interaction diagram illustrating steps by which DMA transfer of payload data and header data is triggered in order to stream the contents of a data file to a client, in accordance with an embodiment of the present invention.

FIG. 6 illustrates additional configurations in which disclosed streaming techniques can be applied in a network environment, in accordance with an embodiment of the present invention.

FIG. 7 depicts an example computer system in which the present invention may be implemented.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Overview

Many households now have access to television programming available on request from a television provider, such as video on demand (“VOD”) services from cable television (“CATV”) providers. VOD services are commonly offered using some variant of the Internet protocol (“IP”) stack, and may be referred to as IP television (“IPTV”).

In order to receive IPTV programming, an IP Gateway or Settop Video Server is commonly utilized as the primary receiver for IPTV programming. The gateway, commonly referred to as a “set-top box,” is generally not dedicated to the IPTV programming function. In accordance with an embodiment of the present invention, the set-top box is also operable to receive traditional CATV programming, including digital and analog signals, and is also operable to record any programming by performing the functions of a digital video recorder (“DVR”). CATV programming is generally used throughout the specification for the purposes of illustration, but one skilled in the relevant arts will appreciate that video programming can be received by other means, such as through a satellite receiver, over-the-air signals, fiber optics, and any other communication medium.

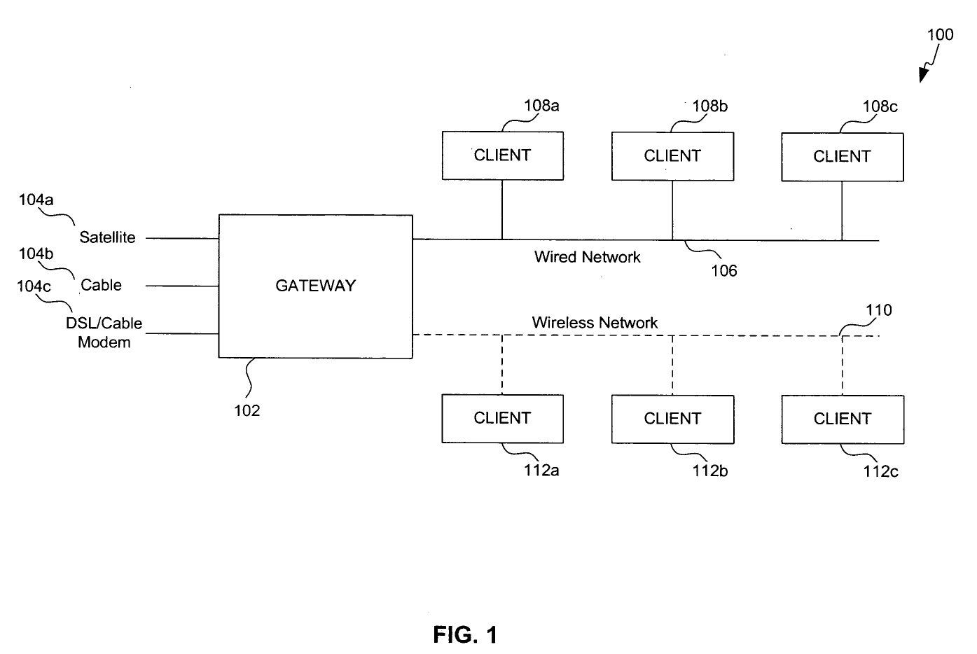

FIG. 1 illustrates an exemplary embodiment of a network 100 designed to distribute streaming video to a client pool, in accordance with an embodiment of the present invention. Gateway 102, which is also a set-top box in accordance with an embodiment of the present invention, is operable to receive IPTV video streams from one or more video sources. Sources 104a-c are exemplary video sources, and include satellite 104a, cable 104b, and DSL/cable modem 104c access to the Internet. One skilled in the relevant arts will appreciate that any technology capable of supporting an IP stack is contemplated by the present invention. In accordance with a further embodiment of the present invention, the video source is a locally stored video file, such as a recording made with DVR capabilities of gateway 102 if available.

Gateway 102 may display IPTV video locally, or may be tasked with distributing the video to one or more clients for display on a monitor attached to the client. Gateway 102 is operable to distribute the streaming video over any network capable of supporting an IP stack, and the network may be either a wired network 106 with wired clients 108a-c or a wireless network 110 with wireless clients 112a-c.

Typically, gateway 102 is operated by a same user that operates any clients, such as wired clients 108a-c or wireless clients 112a-c. In accordance with an embodiment of the present invention, gateway 102 is a central media server operable to transmit or retransmit IPTV programming and clients 108a-c and 112a-c are media clients that are operable to receive and display IPTV programming. For example, if gateway 102 has a stored copy of a video created through the use of its DVR capabilities, any of clients 108a-c or 112a-c can request to stream the copy of the video without the need to copy the video locally.

Video is commonly encoded utilizing the Motion Picture Experts Group (MPEG) encoding standards. For MPEG video requiring approximately 19 megabits per second (“Mbps”) of throughput for a single stream, a standard set-top box such as gateway 102 may have to dedicate as much as 90% of its central processing unit (“CPU”) resources simply to transmit the stream. For this reason, gateway 102 would traditionally only be able to send a single video stream to one of clients 108a-c or 112a-c, and may further not have sufficient processing resources to perform some other available functionality, such as video recording using DVR capabilities. In accordance with an embodiment of the present invention, gateway 102 is such a standard set-top box with limited processing resources. One skilled in the relevant arts will appreciate, however, that even a high-end processor utilized in a system designed for the purpose of acting as a video streaming gateway (commonly called “home media servers”) can benefit from the optimizations disclosed here.

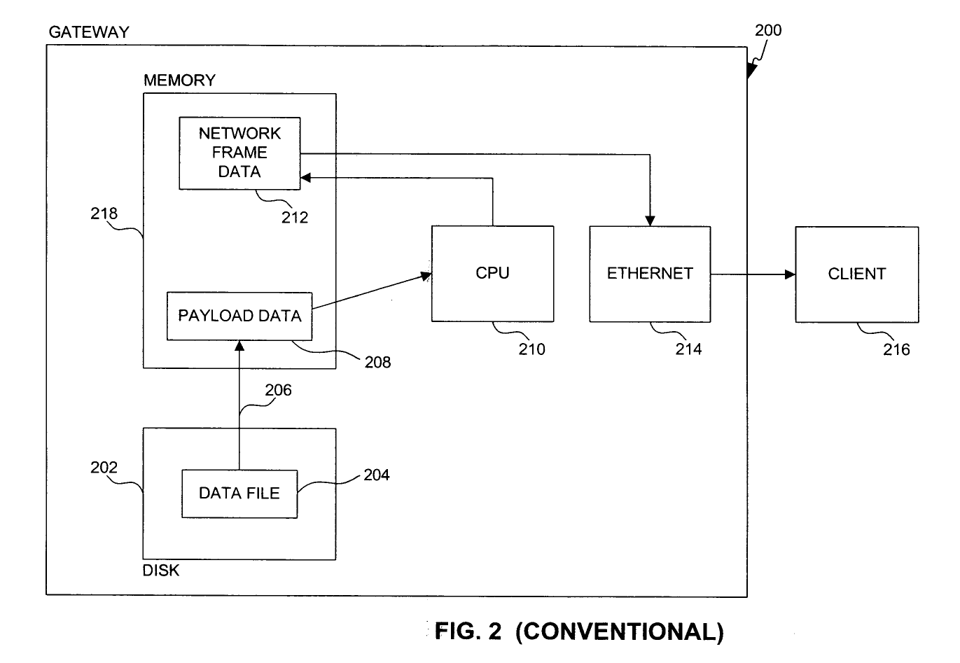

FIG. 2 illustrates a conventional gateway configuration 200 for the purpose of streaming video to a client 216. Gateway 200 comprises some storage medium 202 upon which is recorded a data file 204, such as a video to be watched. This data file 204, or some portion thereof, is retrieved 206 into memory 218 as payload data 208. CPU 210 reads payload data 208 in order to determine how to properly form any requisite network headers for transmission to client 216 over Ethernet module 214. CPU 210 then combines payload data 208 with the network headers to form frame data and writes the formed network frame data 212 to an area of memory accessible by Ethernet module 214, and Ethernet module 214 then sends the network frame data 212 to client 216.

Inefficiencies in the process illustrated in FIG. 2 occur at several points. For example, at various protocol layer transitions (e.g., Ethernet to IP, IP to UDP/TCP) the CPU 210 must compute and add or remove headers, an operation that is computationally intensive for streaming video. If the CPU 210 caches any of the data it is operating on, such as payload data 208 or network frame data 212, the CPU 210 may make any cached data lines dirty and require writing back of the data to memory 218, again resulting in decreased CPU performance.

### II. Eliminating the CPU Bottleneck

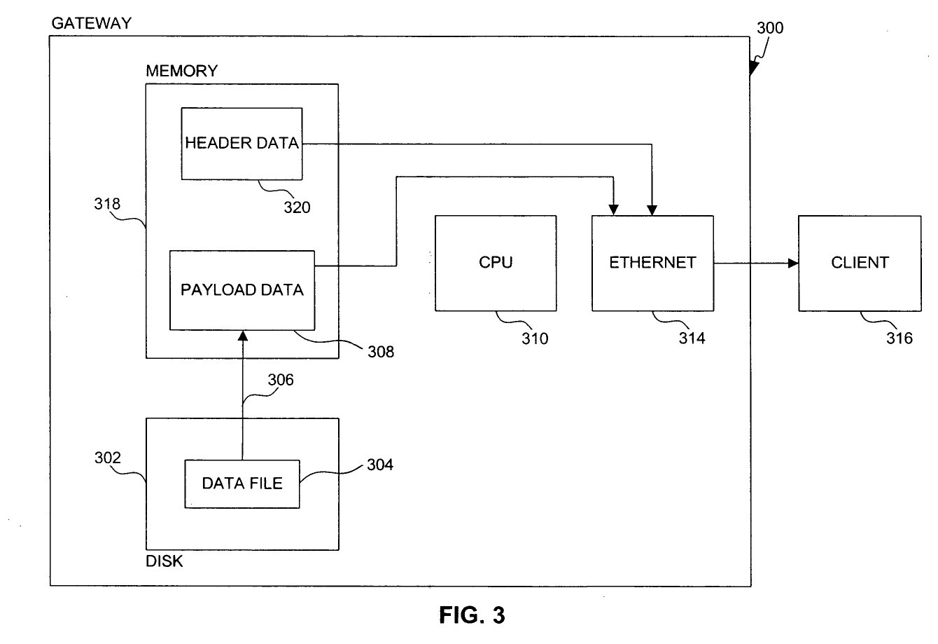

FIG. 3 illustrates a gateway configuration 300 in accordance with an embodiment of the present invention. As in the traditional gateway configuration 200 of FIG. 2, gateway 300 is connected to a client 316 for the purpose of streaming a data file 304 located on a memory device such as disk 302. Ethernet module 314 transmits the data file 304 to client 316 by combining payload data 308, comprising retrieved portions 306 of the data file 304 in memory 318, with header data 320 and sending the payload data 308 and header data 320 as a formed packet to the client 316. One skilled in the relevant arts will appreciate that module 314 is shown as an Ethernet module only for the purposes of illustration and not limitation, and may instead be any networking module found in a gateway 300.

In accordance with an embodiment of the present invention, Ethernet module 314 is capable of direct memory access (“DMA”) and the transmission of packets assembled from separate memory buffers or areas in physical memory. In accordance with an additional embodiment of the present invention, a unified memory architecture and a UDMA capable Ethernet controller are used, as well as a high-precision clock for synchronous transmission.

Since much of the processing time spent by prior art designs is in the computation of headers and in the addition and removal of headers to data packets, the headers needed for transmission of payload data 308 are precomputed and held in memory as header data 320. In accordance with an embodiment of the present invention, client 316 is addressed by sending a data stream to a multicast address, whereby any client situated on the same network as client 316 can receive the data stream and show the streaming data concurrently with other clients. The headers stored as header data 320 are computed as follows.

The Ethernet header comprises a MAC header and data. The MAC header further comprises a destination MAC address, a source MAC address, and an EtherType field. In accordance with an embodiment of the present invention, the destination MAC address is derived from an IP multicast address, such that the six octets of the destination address are 0x01, 0x00, and 0x5E followed by the last 24 bits of the IP multicast IP address. The source MAC address is not important and can be set to any value. The EtherType field is set to 0x08 0x00 to correspond to an IP packet, in accordance with an embodiment of the present invention.

The standard IP header comprises 13 fields, 12 of which are required. In accordance with an embodiment of the present invention, the IP version 4 is used and indicated in the appropriate header field. Furthermore, the header length field is set to indicate that the header has five 32-bit words, unless the 13th optional field is used in a particular implementation. In accordance with an additional embodiment of the present invention, the type of service is selected such that the data stream has network priority (usually a ‘0’ will suffice), the identification is selected as ‘0’ for UDP data as the field is usually ignored for UDP transmissions, and the fragmentation offset is also selected as ‘0’ to indicate that there is no fragmentation. The time-to-live is selected as a small value sufficient to ensure that packets do not travel back upstream through any routers, in accordance with an embodiment of the present invention. The IP destination address is set to a multicast IP group address, the IP source address is set to optionally identify the address of the gateway 300 or to any other value, and the IP protocol field is selected as ‘17’ which corresponds to UDP data.

In accordance with an embodiment of the present invention, the type of service field is selected in order to give priority to the data stream. In accordance with an additional embodiment of the present invention, the identification field is set to zero when transmitting UDP data, as the field is generally ignored for UDP transmissions, and the fragmentation offset is also set to zero.

The IP total length field is determined by adding the size of the UDP headers, below, comprising 8 bytes of data to the IP headers, comprising 20 bytes of data. Finally, the payload length is added in to determine the final total length, in accordance with an embodiment of the present invention. With all of the other fields computed, the IP header checksum is then computed using well-documented checksum computation functions. With the header 4-byte aligned, in accordance with an embodiment of the present invention, a fast checksum function may be substituted. Since the header does not change and does not need to be recomputed, the CPU 310 only needs to compute the header checksum once rather than for each data packet, leading to increased performance gains.

Finally, the UDP header has four fields. A UDP destination port is selected as the desired destination port for the specific application, namely the UDP port of client 316. The checksum and source fields are unused and are set to ‘0’ in order to indicate to the receiver that the fields are unused, in accordance with an embodiment of the present invention. The length field is determined by adding the length of the UDP headers, comprising 8 bytes of data, to the payload length, in accordance with an embodiment of the present invention.

The payload length, as accounted for in the IP and UDP headers, is usually a quantity such that the Ethernet payload is less than 1500 bytes in order to satisfy MTU size restrictions. In accordance with an embodiment of the present invention, video is encapsulated in multiples of 188 bytes, allowing for 7 packets within the payload. Each of the packets may be a separate MPEG transport stream, or may comprise null packets for the purpose of maintaining timing and lowering packet jitter, in accordance with a further embodiment of the present invention. In accordance with an additional embodiment of the present invention, null packets are precomputed and retrieved using DMA mechanisms along with the header and payload.

### III. Forming Data Packets

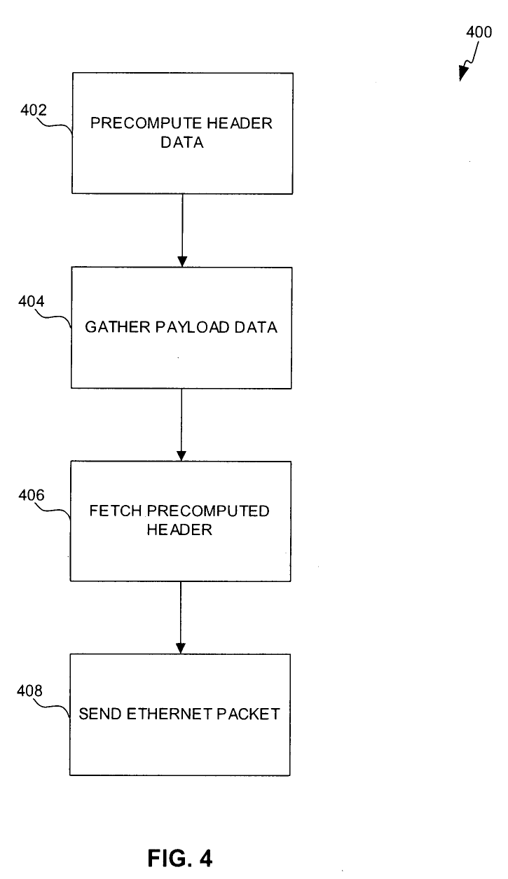

The gateway 300 of FIG. 3 will now be discussed with reference to flowchart 400 of FIG. 4. At step 402, header data is precomputed for a data file. This header data, such as header data 320, corresponds to a data file, such as data file 304 or its corresponding constituent parts in memory such as payload data 308. The header data includes UDP, IP, and Ethernet headers, in accordance with an embodiment of the present invention.

At step 404, Ethernet module 314 gathers payload data 308 and fetches precomputed header data 320 at step 406 to form a data packet. In accordance with an embodiment of the present invention, header data 320 and payload data 308 are stored in different locations of memory 318, and Ethernet module 314 is able to request this data from various locations in the memory 318 using DMA. At step 408, the formed Ethernet packet comprising headers and payload is sent to client 316. One skilled in the relevant arts will appreciate that steps 404 and 406 need not occur in the order presented.

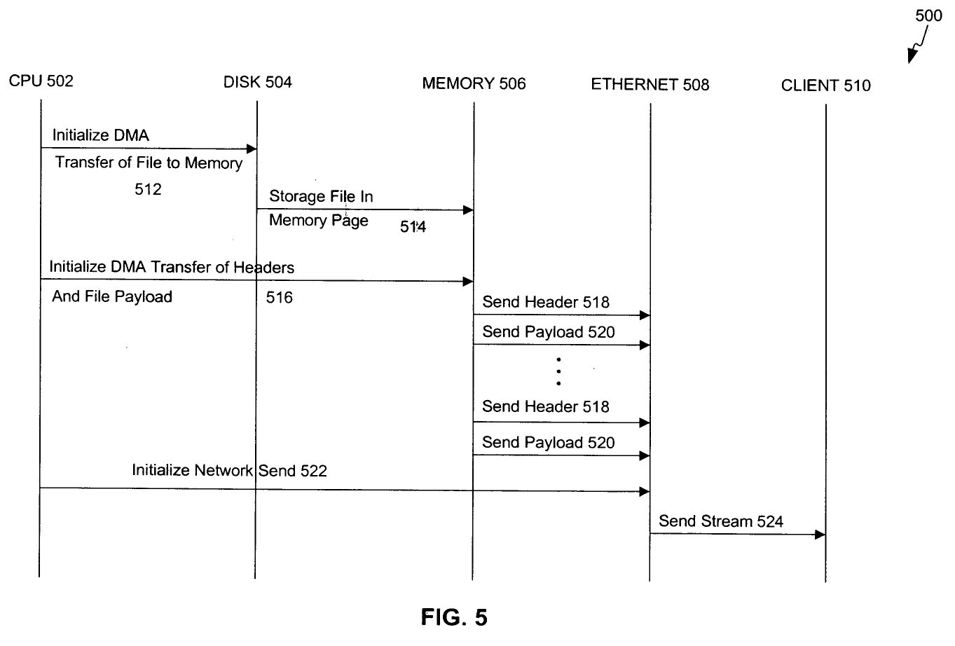

FIG. 5 is a signal flow/interaction diagram 500 illustrating steps by which DMA transfer of payload data 308 and header data 320 from FIG. 3 is triggered in order to stream the contents of data file 304 to client 316, in accordance with an embodiment of the present invention. In accordance with an additional embodiment of the present invention, although the CPU 502 is removed from the processing path, the CPU 502 is still used to control the initialization of DMA transfers. At step 512, CPU 502 sends a DMA request to disk 504 indicating that data file 304 should be stored in memory. Subsequently, at step 514, disk 504 stores a copy of file 304 in memory 506.

CPU 502 then initializes DMA transfer of payload data 308 and header data 320 to Ethernet module 314 at step 516. Accordingly, at step 518 the header data is sent from memory 506 to Ethernet module 508, and then the payload data is sent at step 520 to form a data packet. Steps 518 and 520 are repeated until sufficient information has been received by Ethernet module 508 such that it is ready to send the data. At step 522, CPU 502 triggers the transmission of the formed packets, and Ethernet module 508 sends the stream at step 524 to client 510.

### IV. Variations

In accordance with an embodiment of the present invention, the header data, such as header data 320 in FIG. 3, is not precomputed but is instead computed by CPU 310 on the fly. However, in the embodiment, the CPU 310 does not look at payload data 308 in the process of computing header data 320, and furthermore Ethernet module 314 is operable to obtain header data from the CPU 310 along with payload data 308 from memory 318 without the need to form the packets in memory ahead of time. This additional transmission cannot involve the CPU 310 in order to realize performance benefits.

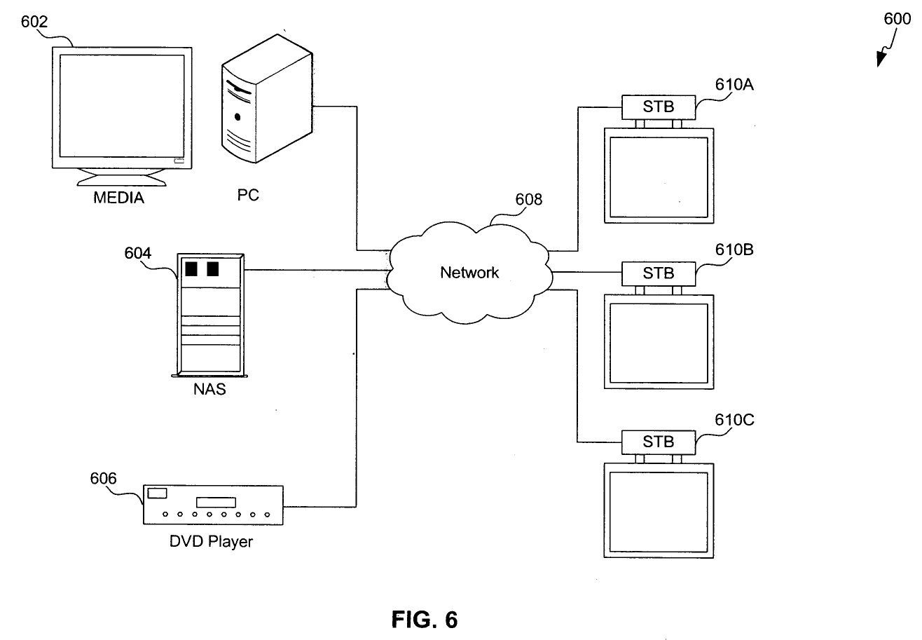

An additional variation in accordance with an embodiment of the present invention is the use of the disclosed techniques in other network accessible devices. FIG. 6 illustrates other scenarios in which the techniques described with reference to IPTV can be applied in a network environment 600, in accordance with an embodiment of the present invention. For example, a media PC 602 can be utilized as a centralized storage solution, not only for streaming video but other data types as well, including streaming audio and applications. Similarly, network attached storage (“NAS”) 604 can be used to stream data. Even a DVD player such as DVD player 606 can have the requisite networking technology to transmit streaming video. For each of the stated examples, a network 608 provides the connection to one or more set top boxes 610a-c. One skilled in the relevant arts will appreciate that network 608 may be either a wired or wireless network, and may include connection types such as Ethernet, USB, or FireWire.

Yet another embodiment of the present invention is the use of a gateway connected to a transponder for a satellite utilizing QAM-256/64 modulation. Utilizing efficient encoding, such as the MPEG4 standard, the described method results in the ability to transmit approximately 5-6 high definition video streams over network 608 to clients (set-top box clients) 610a-c. One such application is in the hotel business where client set-top boxes in hotel rooms are connected to a central gateway that is operable to serve satellite signals from a single satellite source. Additional streams can also be supported by increasing the MTU size to support larger Ethernet frames, in accordance with an embodiment of the present invention.

### V. Example Computer System Implementation

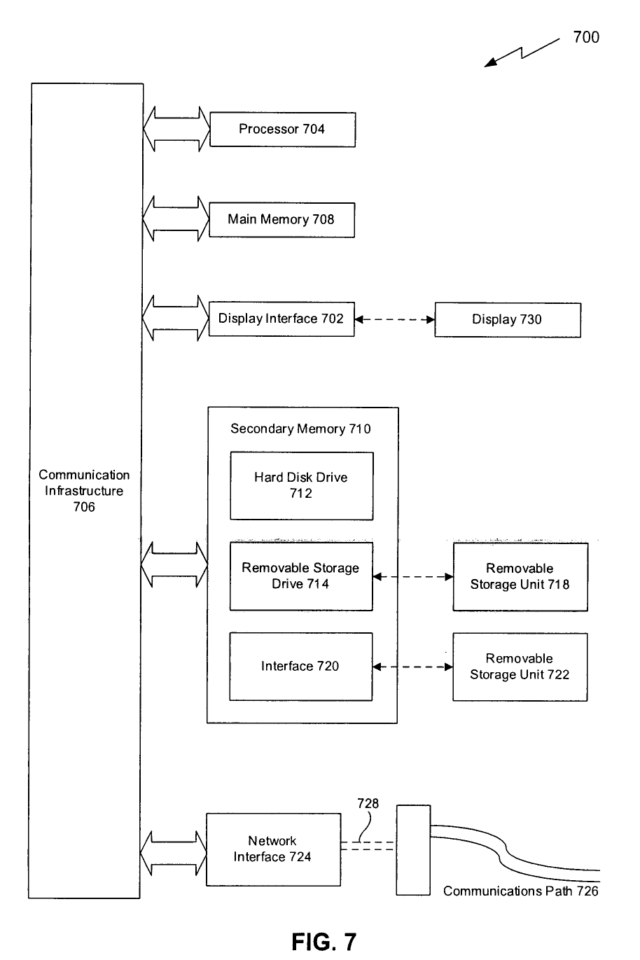

Various aspects of the present invention can be implemented by software, firmware, hardware, or a combination thereof. FIG. 7 illustrates an example computer system 700 in which the present invention, or portions thereof, can be implemented as computer-readable code. For example, the methods illustrated by flowchart 400 of FIG. 4 can be implemented in system 700. Various embodiments of the invention are described in terms of this example computer system 700. After reading this description, it will become apparent to a person skilled in the relevant art how to implement the invention using other computer systems and/or computer architectures.

Computer system 700 includes one or more processors, such as processor 704. Processor 704 can be a special purpose or a general purpose processor. Processor 704 is connected to a communication infrastructure 706 (for example, a bus or network).

Computer system 700 also includes a main memory 708, preferably random access memory (RAM), and may also include a secondary memory 710. Secondary memory 710 may include, for example, a hard disk drive 712, a removable storage drive 714, and/or a memory stick. Removable storage drive 714 may comprise a floppy disk drive, a magnetic tape drive, an optical disk drive, a flash memory, or the like. The removable storage drive 714 reads from and/or writes to a removable storage unit 718 in a well known manner. Removable storage unit 718 may comprise a floppy disk, magnetic tape, optical disk, etc. which is read by and written to by removable storage drive 714. As will be appreciated by persons skilled in the relevant art(s), removable storage unit 718 includes a computer usable storage medium having stored therein computer software and/or data.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communications interface 724. Communications interface 724 allows software and data to be transferred between computer system 700 and external devices. Communications interface 724 may include a modem, a network interface (such as an Ethernet card), a communications port, a PCMCIA slot and card, or the like. Software and data transferred via communications interface 724 are in the form of signals which may be electronic, electromagnetic, optical, or other signals capable of being received by communications interface 724. These signals are provided to communications interface 724 via a communications path 726. Communications path 726 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 718, removable storage unit 722, a hard disk installed in hard disk drive 712, and signals carried over communications path 726. Computer program medium and computer usable medium can also refer to memories, such as main memory 708 and secondary memory 710, which can be memory semiconductors (e.g. DRAMs, etc.). These computer program products are means for providing software to computer system 700.

Computer programs (also called computer control logic) are stored in main memory 708 and/or secondary memory 710. Computer programs may also be received via communications interface 724. Such computer programs, when executed, enable computer system 700 to implement the present invention as discussed herein. In particular, the computer programs, when executed, enable processor 704 to implement the processes of the present invention, such as the steps in the methods illustrated by flowchart 400 of FIG. 4 discussed above. Accordingly, such computer programs represent controllers of the computer system 700. Where the invention is implemented using software, the software may be stored in a computer program product and loaded into computer system 700 using removable storage drive 714, interface 720, hard drive 712 or communications interface 724.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for streaming data at a high bit rate, comprising:
computing header data for the data stream, wherein the header data is computed by a processor prior to transmission of the data stream;
gathering payload data in a network module, wherein the payload data corresponds to a constituent portion of the data stream;
fetching the precomputed header data in a network module to form a data packet, wherein the precomputed header data is stored in a separate memory location from the payload data; and
transmitting the formed data packet by sending the precomputed header data along with the gathered payload data in a network module.

2. The method of claim 1, further comprising:
triggering, in the processor, the step of gathering payload data in the network module.

3. The method of claim 1, further comprising:
triggering, in the processor, the step of fetching the precomputed header data in the network module.

4. The method of claim 1, further comprising:
triggering, in the processor, the step of transmitting the formed data packet in the network module.

5. The method of claim 1, wherein the payload data and precomputed header data are stored in a memory.

6. The method of claim 5, wherein the network module is operable to perform the steps of gathering the payload data, fetching the precomputed header, and transmitting the formed data packet using direct memory access to the memory.

7. The method of claim 1, wherein the data stream is an Internet protocol television data stream.

8. The method of claim 1, wherein the data stream is a signal from a satellite transponder.

9. The method of claim 1, wherein the header data comprises a UDP header, an IP header, and an Ethernet header.

10. The method of claim 1, wherein the formed data packet is transmitted without storing the formed data packet in memory.

11. A computer program product comprising a computer usable medium having computer program logic recorded thereon for enabling a processor to stream data at a high bit rate, the computer program logic comprising:
computing means for enabling a processor to compute header data for the data stream, wherein the header data is computed by the processor prior to transmission of the data stream;
gathering means for enabling a processor to gather payload data in a network module, wherein the payload data corresponds to a constituent portion of the data stream;
fetching means for enabling a processor to fetch the precomputed header data in a network module to form a data packet, wherein the precomputed header data is stored in a separate memory location from the payload data; and
transmitting means for enabling a processor to transmit the formed data packet by sending the precomputed header data along with the gathered payload data in a network module.

12. The computer program logic of claim 11, further comprising:
triggering means for enabling a processor to trigger the step of gathering payload data in the network module.

13. The computer program logic of claim 11, further comprising:
triggering means for enabling a processor to trigger the step of fetching the precomputed header data in the network module.

14. The computer program logic of claim 11, further comprising:
triggering means for enabling a processor to trigger the step of transmitting the formed data packet in the network module.

15. The computer program logic of claim 11, wherein the payload data and precomputed header data are stored in a memory.

16. The computer program logic of claim 15, wherein the network module is operable to perform the gathering means, fetching means, and transmitting means using direct memory access to the memory.

17. The computer program logic of claim 11, wherein the data stream is an Internet protocol television data stream.

18. The computer program logic of claim 11, wherein the data stream is a signal from a satellite transponder.

19. The computer program logic of claim 11, wherein the header data comprises a UDP header, an IP header, and an Ethernet header.

20. The computer program logic of claim 11, wherein the transmitting means is performed without storing the formed data packet in memory.

21. A system capable of streaming data at a high bit rate, comprising:
a first module to compute header data for the data stream, wherein the header data is computed by a processor prior to transmission of the data stream;
a second module to gather payload data in a network module, wherein the payload data corresponds to a constituent portion of the data stream;
a third module to fetch the precomputed header data in a network module to form a data packet, wherein the precomputed header data is stored in a separate memory location from the payload data; and
a fourth module to transmit the formed data packet by sending the precomputed header data along with the gathered payload data in a network module.
